(19) United States
(12) Patent Application Publication
(10) Pub. No.: US 2005/0073168 A1
(43) Pub. Date: Apr. 7, 2005

(54) Visor gap shade

(76) Inventor: Gerardo Herrera, Carol Stream, IL (US)

Correspondence Address: Gerardo Herrera, Apt. 1-A, 160 Greenway Trail, Carol Stream, IL, 60188-1658, US

(21) Appl. No.: 10/955,752

(22) Filed: Sep. 30, 2004

Related U.S. Application Data
(60) Provisional application No. 60/507,894, filed on Oct. 1, 2003.

(51) Int. Cl. B60J 3/00

(52) U.S. Cl. 296/97.1

(57) ABSTRACT

An visor gap shade (20) to bridge the gap between a pair of conventional, pivotable sun visors (40), including the space between the ceiling/headliner (48) of a motor vehicle and the top longitudinal edge of the rearview mirror (32). The visor gap shade (20) has a particularly simple structure and is capable of being easily folded into a compact configuration for storage. The visor gap shade (20) is comprised of a single, elongated, continuous, closed loop (26) and support rings 27 of a thin strip of spring-like material covered by a sheet (22) of one or more layers of a flexible material. The shape of the single, elongated, continuous, closed loop (26) can vary from a generally rectangular shape to an generally oval shape to a generally elliptical shape. In its normally open configuration, the visor gap shade (20) is placed above and behind a motor vehicle's rearview mirror (32) and frictionally straddles the periphery of its post (36) or one of its stems (38) in such a way as not to interfere with the function and use of the pair of conventional, pivotable sun visors (40). The single, elongated, continuous, closed, fabric-covered loop (26) of the visor gap shade (20) can be easily twisted and folded into a compact configuration consisting of a series of smaller concentric loops and fabric layers. The visor gap shade (20) may comprise a method for maintaining the compact configuration for storage, or it may not be collapsed or folded. The visor gap shade (20) may additionally comprise a method for attachment to the ceiling/headliner (48) above the driver's or front seat passenger's side window to serve a second function: to provide an extended area of shade when a conventional, pivotable sun visor (40) is placed and used in the side and down position.

### CROSS-REFERENCE TO RELATED APPLICATIONS

This application claims the benefit of PPA Ser. Nr. 60/507,894, filed 2003 Oct. 01 by the present inventor.

### FEDERALLY SPONSORED RESEARCH

None.

### SEQUENCE LISTING

None.

### BACKGROUND OF THE INVENTION

1. Field of Invention

This invention relates to a new and novel auxiliary sun visor to bridge the gap between a pair of conventional, pivotable sun visors found in many modern and older motor vehicles.

Many modem and older motor vehicles are equipped with a pair of conventional, pivotable sun visors attached to the ceiling/headliner. These sun visors are generally spaced some distance apart from each other, and a rearview mirror is generally mounted between them and at some distance from the ceiling/headliner of the vehicle. When the sun visors are in the down or in use position, they usually leave a gap between them; a considerable area above and around the rearview mirror is left unprotected against the direct rays of the sun, bright light, and the like.

This invention also relates to a new and novel auxiliary sun visor to provided an extended area of shade when a pair of conventional, pivotable sun visors found in many modern and older motor vehicles are placed and used in the side and down position.

When the sun visors are placed and used in the side and down position they often leave a significant area uncovered and through which a driver and front seat passenger are exposed to the direct rays of the sun, bright light, and the like.

2. Discussion of Prior Art

In an attempt to bridge the gap between a pair of conventional, pivotable sun visors usually found in many modem and older motor vehicles, it appears that three basic categories of auxiliary sun visors exist at present: 1) Mechanical, 2) Semi-mechanical, and 3) Non-mechanical.

The mechanical auxiliary sun visors conceived tend to be complicated in design, costly to manufacture, and cumbersome to install (see U.S. Pat. No. 4,558,899 to Chu, et al (1985); U.S. Pat. No. 4,971,383 to Tawaraya (1990); U.S. Pat. No. 6,527,329 to Bauer (2003)).

Furthermore, as mechanical devices are prone to do, they will eventually suffer mechanical malfunction or failure and need repair. As such, the repair or replacement of these units may be costly, time consuming, or both.

Although simpler in design and less costly to manufacture, the semi-mechanical auxiliary sun visors still tend to require some amount of labor to install. Furthermore, they also require some hardware in order to function properly (see U.S. Pat. No. 2,163,495 to Levy (1939); U.S. Pat. No. 2,252,716 to Levy (1941); U.S. Pat. No. 2,485,440 to Friedheim (1949); U.S. Pat. No. 2,970,864 to McCann, Jr. (1961); U.S. Pat. No. 3,791,476 to Wernig (1974); U.S. Pat. No. 4,275,917 to Marcus (1981); U.S. Pat. No. 4,363,512 to Marcus (1982); U.S. Pat. No. 4,512,605 to Aschermann, et al (1985); U.S. Pat. No. 4,773,696 to Steele (1988); U.S. Pat. No. 4,792,176 to Karford (1988); U.S. Pat. No. 4,902,063 to Crink (1990); U.S. Pat. No. 4,925,233 to Clark (1990); U.S. Pat. No. 4,940,273 to Konishi (1990); U.S. Pat. No. 4,974,896 to Konishi (1990); U.S. Pat. No. 4,998,765 to Van Order, et al (1991); U.S. Pat. No. 5,004,288 to Viertel, et al (1991); U.S. Pat. No. 5,026,108 to Leahy (1991); U.S. Pat. No. 5,042,867 to Crotty, et al (1991); U.S. Pat. No. 5,044,687 to Abu-Shumay, et al (1991); U.S. Pat. No. 5,064,238 to Mohtasham (1991); U.S. Pat. No. 5,150,258 to Schmidt (1992); U.S. Pat. No. 5,211,439 to Smith (1993); U.S. Pat. No. 5,271,653 to Shirley (1993); U.S. Pat. No. 5,316,361 to Miller (1994); U.S. Pat. No. 5,409,285 to Snyder, et al (1995); U.S. Pat. No. 5,494,328 to Lehr (1996); U.S. Pat. No. 5,575,523 to Keller (1996); U.S. Pat. No. 5,645,308 to Fink (1997); U.S. Pat. No. 5,678,880 to Keller (1997); U.S. Pat. No. 5,765,899 to Watjer, et al (1998); U.S. Pat. No. 5,810,419 to Lam (1998); U.S. Pat. No. 5,964,494 to Miller (1999); U.S. Pat. No. 6,010,174 to Murdock, et al (2000); U.S. Pat. No. 6,059,347 to Davalos (2000); U.S. Pat. No. 6,189,949B1 to Miller, et al (2001); U.S. Pat. No. 6,328,370 to Kim (2001); U.S. Pat. No. 6,585,308B2 to Sturt, et al (2003); U.S. Pat. No. 6,682,122 to Prokhorov (2004); Pub. No.: US 2002/0135197 A1 to Howard (2002); DE Pat. No. 19,827,216 to Garden-Rothmayer (2000): DE Pat. No. 19,848,771 to Garden-Rothmayer (2000); FR Pat. No. 2795686 to Renault (2001); FR Pat. No. 2795692 to Renault (2001)). Should any hardware piece or pieces be missing, defective, or damaged, then these devices will not function properly, if at all. Additionally, most, if not all, of the semi-mechanical auxiliary sun visors fail to provide sufficient shade above and around a motor vehicle's rearview mirror mounted between a pair of conventional, pivotable sun visors and at some distance from the ceiling/headliner.

Non-mechanical auxiliary sun visors usually have simpler designs, require no hardware, are less expensive to manufacture, and are easier to use. However, the majority, if not all, still suffer from certain drawbacks. Most non-mechanical auxiliary sun visors usually have rigid, stiff structures that make them non-collapsible for easy, quick storage when not in use (see U.S. Pat. No. 6,296,294B1 to Kohnle, et al (2001)). Also, most, if not all, non-mechanical auxiliary sun visors are of a set size, shape, and/or bulk that limits the model and number of vehicles in which they can be used effectively to provide 100% coverage and shade; they are not adjustable; one size does not fit all (see U.S. Pat. No. 2,620,222 to Beauchamp (1952); U.S. Pat. No. 4,353,593 to Henson (1982); U.S. Pat. No. 4,818,011 to Cherian (1989); U.S. Pat. No. 4,842,322 to Iu (1989); U.S. Pat. No. 4,861,091 to Wallen (1989); U.S. Pat. No. 4,862,944 to Hendershot (1989); U.S. Pat. No. 4,958,879 to Gillum (1990); U.S. Pat. No. 5,333,927 to PreJean (1994); U.S. Pat. No. 6,279,984 to Reina, Jr. (2001); DE Pat. No. 19,900,615 to Garden-Rothmayer (2000); FR Pat. No. 2553352 to Royere (1985); FR Pat. No. 2784056 to DiBernardo (2000)). Other non-mechanical auxiliary sun visors are designed in such a way as to block a portion of a driver's view when adjusted downward from beneath a motor vehicle's rearview mirror (see U.S. Pat. No. 2,549,395 to Short, Sr. (1951); U.S. Pat. No. 4,172,613 to Furando (1979); U.S. Pat. No. 5,979,967 to Poulson (1999)). Still other non-mechanical auxiliary sun visors suffer from a complicated design that requires the use of two hands in order for them to be properly installed and adjusted to a motor vehicle's particular make and model (see U.S. Pat. No. 6,513,855 B2 to Zenisek (2003)).

In an attempt to provide shade to a driver and front seat passenger when a pair of conventional, pivotable sun visors is placed and used in the side and down position, it appears two basic categories of auxiliary sun visors exist at present: 1) Semi-Mechanical and 2) Non-Mechanical auxiliary sun visors.

Within the category of semi-mechanical auxiliary sun visors conceived to provide shade over a portion of a driver's or front seat passenger's side window, five types appear to exist at present:
1. the front and side sun visor panel without slideable extensions type (see U.S. Pat. No. 4,195,876 to Timperio (1980); U.S. Pat. No. 5,150,258 to Saxman (1992); U.S. Pat. No. 4,666,205 to Nakagawa (1987); U.S. Pat. No. 4,681,363 to Hemmeke, et al (1987); U.S. Pat. No. 4,690,450 to Boerema, et al (1987); U.S. Pat. No. 4,844,530 to Mahler, et al (1989); U.S. Pat. No. 4,925,232 to Hemmeke, et al (1990); U.S. Pat. No. 4,950,021 to Vandagriff (1990); U.S. Pat. No. 5,071,186 to Hemmeke, et al (1991); U.S. Pat. No. 5,080,420 to Hemmeke, et al (1992); U.S. Pat. No. 5,158,334 to Felland (1992); U.S. Pat. No. 5,44,244 to Gute, et al (1993); U.S. Pat. No. 5,417,466 to Giantonio, et al (1995); U.S. Pat. No. 5,472,255 to Moore (1995); U.S. Pat. No. 5,580,117 to Goclowski (1996); U.S. Pat. No. 5,626,381 to Gervasoni, et al (1997); U.S. Pat. No. 6,189,947B1 to Annan (2001); U.S. Pat. No. 6,296,293 to Peterson, et al (2001));
2. the front and side sun visor panel with slideable extensions type (see U.S. Pat. No. 4,762,359 to Boerema, et al (1988); U.S. Pat. No. 4,783,111 to Hemmeke, et al (1988); U.S. Pat. No. 4,913,483 to Jasso (1990): U.S. Pat. No. 5,967,587 to Collet, et al (1999));
3. the front and side slideable sun visor panel type (see U.S. Pat. No. 5,161,850 to Redder (1992); U.S. Pat. No. 5,292,168 to Mykytiuk, et al (1994); U.S. Pat. No. 5,951,091 to Vander Kuyl, et al (1999));
4. the sun visor assembly type (see U.S. Pat. No. 5,390,973 to Melotti (1995);
5. the courtesy handle sun visor type (see U.S. Pat. No. 4,792,177 to Svensson).

Within the category of non-mechanical auxiliary sun visors conceived to provide shade over a portion of a driver's or front seat passenger's side window, four types appear to exist at present:
1. the hanging sun visor type (see U.S. Pat. No. 6,309,004B1 to McNutt, et al (2001); U.S. Pat. No. 5,611,590 to Filgueiras (1997));
2. the portable glare shield type (see U.S. Pat. No. 4,746,162 to Maness (1988));
3. the multiple panels type (see U.S. Pat. No. 4,944,548 to Payne, et al (1990));
4. the magnetic sun visor panel type (see U.S. Pat. No. 5,040,841 to Yang (1991).

Those devices which are simple in design, easy to use, lightweight, flexible, collapsible, easily stored, and/or economical to manufacture are not designed to serve either of the two functions of the dual auxiliary sun visor of the present application (see U.S. Pat. No. 4,815,784 to Zheng (1989); U.S. Pat. No. 5,024,262 to Huang (1991); U.S. Pat. No. 5,267,599 to Kim (1993); U.S. Pat. No. 5,378,518 to Wang (1995); U.S. Pat. No. 5,417,467 to Viertal (1995); U.S. Pat. No. 5,452,934 to Zheng (1995); U.S. Pat. No. 5,628,357 to Hwang (1997); U.S. Pat. No. 5,632,318 to Wang (1997); U.S. Pat. No. 5,732,759 to Wang (1998); U.S. Pat. No. 6,289,968 to Karten, et al (2001)

Finally, all of the aforementioned auxiliary sun visors suffer from the same drawback: single-purpose functionality. Those auxiliary sun visors dedicated to bridging the gap between a pair of conventional, pivotable sun visors found in many modem and older motor vehicles cannot also provide an extended area of shade when the pair of sun visors is placed and used in the side and down position. Thus, all of the aforementioned auxiliary sun visors can serve either one function or the other exclusively; they cannot go from one function to the other when necessary.

### BACKGROUND OF THE INVENTION—OBJECTS AND ADVANTAGES

It is the primary object of the auxiliary sun visor to provide a simple, reliable, lightweight, flexible, adjustable, effective, economical, inexpensive, portable and/or compactable device to protect the eyes of a driver and front seat passenger from the discomfort and possible dangers of sunlight, bright lights, and the like coming in through that portion of a windshield above and around a rearview mirror not covered by a pair of conventional, pivotable sun visors mounted in many modern and older motor vehicles.

It is the secondary object of the auxiliary sun visor to provide an extended area of shade to a driver and front seat passenger when a pair of conventional, pivotable sun visors mounted in many modem and older motor vehicles is placed and used in the side and down position.

Accordingly, besides the object(s) and advantage(s) of the auxiliary sun visor described above and elsewhere in this patent application, several objects and advantages of the present application are:
(a) to provide a motor vehicle auxiliary sun visor that requires a minimum amount of material and is simple and economical to manufacture.
(b) to provide a motor vehicle auxiliary sun visor that is inexpensive.
(c) to provide a motor vehicle auxiliary sun visor that is adjustable.
(d) to provide a motor vehicle auxiliary sun visor that is portable.
(e) to provide a motor vehicle auxiliary sun visor that will work effectively on a wide variety of makes and models of foreign and domestic motor vehicles.
(f) to provide a motor vehicle auxiliary sun visor that will work on either windshield-mounted or ceiling/headliner-mounted rearview mirrors.
(g) to provide a motor vehicle auxiliary sun visor that has a surface that is tinted, translucent, or opaque enough to sufficiently reduce or significantly block the sunlight that usually shines above and around a rearview mirror mounted between a pair of conventional, pivotable sun visors and hits the eyes of a driver and front seat passenger.
(h) to provide a motor vehicle auxiliary sun visor comprised of a sheet of flexible material with an elongated, continuous loop of spring-like material attached along the perimeter of the sheet.
(i) to provide a motor vehicle auxiliary sun visor having a particularly simple structure comprised of an elongated, continuous loop and one or more support rings of spring-like material covered by a thin flexible material to form a sheet of one or more layers.
(j) to provide a motor vehicle auxiliary sun visor which when deployed for use has an open, extended configuration maintained by an elongated, continuous, closed loop and one or more support rings of a spring-like material in the form of thin metal or plastic or composite strips that possess the property of springiness.
(k) to provide a motor vehicle auxiliary sun visor which is comprised of an elongated, continuous, fabric-covered loop and support ring(s) of a generally rectangular, generally elliptical, or generally oval shape.
(l) to provide a motor vehicle auxiliary sun visor comprised of an elongated, continuous, fabric-covered loop and support ring(s) which can be easily and conveniently twisted and folded into a compact configuration for storage.
(m) to provide a motor vehicle auxiliary sun visor including a way for maintaining a compact configuration of the auxiliary sun visor when it is not in use.
(n) to provide a motor vehicle auxiliary sun visor that is not collapsible or foldable but remains flexible, springy, and adjustable.
(o) to provide a motor vehicle auxiliary sun visor that can be easily modified to include a way for attachment to the ceiling/headliner above a driver's and front seat passenger's side window.
(p) to provide a motor vehicle auxiliary sun visor that can serve a second function: to provide an extended area of shade when a conventional, pivotable sun visor is placed and used in the side and down position.

### SUMMARY

In accordance with the visor gap shade in a preferred embodiment, I submit an adjustable, portable, flexible, compactly foldable motor vehicle auxiliary sun visor comprised of an elongated, continuous, closed loop and one or more support rings of a thin strip of spring-like material covered by a sheet of one or more layers of a flexible material.

In its normally open configuration, the visor gap shade is placed above and behind a motor vehicle's rearview mirror that is mounted between a pair of conventional, pivotable sun visors and at some distance from the ceiling/headliner. In the case of a windshield-mounted rearview mirror, the visor gap shade is placed between the rearview mirror's mounting post or one of its stems and the edge of the motor vehicle's ceiling/headliner where it meets the top edge of the front windshield. In the case of a ceiling/headliner-mounted rearview mirror, the visor gap shade is placed between the stems (top and bottom) of the rearview mirror's mounting post. Thus, light from the sun, bright lights, and the like is thereby sufficiently reduced or significantly prevented from reaching the eyes of a driver and front seat passenger when both sun visors are placed and used in the side and down position.

The elongated, continuous, closed, fabric-covered loop and support ring(s) of the visor gap shade can be easily twisted and folded into a compact configuration consisting of a series of smaller concentric loops and fabric layers. In its compact configuration, the visor gap shade is easily stored. The visor gap shade may additionally comprise a way for maintaining the compact configuration for storage.

The visor gap shade's single, elongated, continuous, closed, flexible, spring-like loop and its support ring(s) are made of either plastic, metal, or some other material that has the property of springiness. The exact shape of the elongated, continuous, closed, fabric-covered loop of spring-like material can vary from a generally rectangular shape to a generally oval shape to a generally elliptical shape. The thin strip of spring-like material used to maintain the shape of the visor gap shade in its open configuration can be secured to a sheet of flexible material along its outer perimeter, thus making up the major part of the visor gap shade. In variations on the preferred embodiment, portions of the sheet of flexible material may extend beyond points at which the strip of spring-like material is secured. In still other variations on the preferred embodiment, the sheet of flexible material may be tinted, translucent, shaded, or comprised of polarized material or the like so as to allow the driver to see through it but not be hindered by direct sunlight, bright lights, or the like.

Because the visor gap shade's single, elongated, continuous, closed, flexible loop and its support ring(s) are made of spring-like material, it is adjustable and better able to cover wide or narrow gaps between a motor vehicle's ceiling/headliner and the top edge of a rearview mirror.

Finally, the visor gap shade can be easily modified with a method to affix it above a driver's side window or front seat passenger's side window to provide an extended area of shade when a conventional, pivotable sun visor is placed and used in the side and down position.

### DRAWINGS—FIGURES

FIG. 1A is a rear side view of the preferred embodiment of visor gap shade 20 constructed in accordance with the invention showing it in the general shape of a rectangle, its corners slightly rounded, its latitudinal ends at a slight angle, its longitudinal edges parallel to each other, an arch 30 at the center of its bottom, longitudinal edge, and a section of it cut away to reveal its underlying structure.

FIG. 1B is a front side view of FIG. 1A showing visor gap shade 20 whole and intact.

FIG. 2A is a rear side view of an alternate embodiment of visor gap shade 20 constructed in accordance with the invention showing it in the general shape of a rectangle with square corners, its latitudinal ends parallel to each other, its longitudinal edges parallel to each other, an arch 30 at the center of its bottom longitudinal edge, and a section of it cut away to reveal its underlying structure.

FIG. 2B is a front side view of FIG. 2A showing visor gap shade 20 whole and intact.

FIG. 3A is a rear side view of an alternate embodiment of visor gap shade 20 constructed in accordance with the invention showing it in the general shape of a rectangle with slightly rounded corners, its latitudinal ends parallel to each other, its longitudinal edges parallel to each other, an arch 30 at the center of its bottom longitudinal edge, and a section of it cut away to reveal its underlying structure.

FIG. 3B is a front side view of FIG. 3A showing visor gap shade 20 whole and intact.

FIG. 4A is a rear side view of an alternate embodiment of visor gap shade 20 constructed in accordance with the invention showing it in the general shape of an ellipse with an arch 30 at the center of its bottom longitudinal edge and a section of it cut away to reveal its underlying structure.

FIG. 4B is a front side view of FIG. 4A showing visor gap shade 20 whole and intact.

FIG. 5A is a rear side view of an alternate embodiment of visor gap shade 20 constructed in accordance with the invention showing it in the general shape of a rectangle, its latitudinal ends at a slight angle, its longitudinal edges parallel to each other, an arch 31 at the center of its top longitudinal edge, an arch 30 at the center of its bottom longitudinal edge, and a section of it cut away to reveal its underlying structure.

FIG. 5B is a front side view of FIG. 5A showing visor gap shade 20 whole and intact.

FIG. 6A is a rear side view of an alternate embodiment of visor gap shade 20 constructed in accordance with the invention showing it in the general shape of a rectangle with square corners, its latitudinal ends parallel to each other, its longitudinal edges parallel to each other, an arch 31 at the center of its top longitudinal edge, an arch 30 at the center of its bottom longitudinal edge, and a section of it cut away to reveal its underlying structure.

FIG. 6B is a front side view of FIG. 6A showing visor gap shade 20 whole and intact.

FIG. 7A is a rear side view of an alternate embodiment of visor gap shade 20 constructed in accordance with the invention showing it in the general shape of a rectangle with slightly rounded corners, its latitudinal ends parallel to each other, its longitudinal edges parallel to each other, an arch 31 at the center of its top longitudinal edge, an arch 30 at the center of its bottom longitudinal edge, and a section of it cut away to reveal its underlying structure.

FIG. 7B is a front side view of FIG. 7A showing visor gap shade 20 whole and intact.

FIG. 8A is a rear side view of an alternate embodiment of visor gap shade 20 constructed in accordance with the invention showing it in the general shape of an ellipse with and arch 31 at the center of its top longitudinal edge, an arch 30 at the center of its bottom longitudinal edge, and a section of it cut away to reveal its underlying structure.

FIG. 8B is a front side view of FIG. 8A showing visor gap shade 20 whole and intact.

FIG. 9 is a fragmented perspective view of the front windshield area of an automobile as seen from the inside with sun visors 40 in the down or in use position and a specifically configured version of the preferred embodiment of visor gap shade 20 fully deployed and placed between a rearview mirror's post 36 or stem 38 and the front edge of the automobile's ceiling/headliner 48 where it meets the top edge of the windshield 44.

FIG. 10 is a fragmented perspective view of the windshield area of an automobile as seen from the outside with its sun visors 40 in the down or in use position and a specifically configured version of the preferred embodiment of the visor gap shade 20 fully deployed and placed between a rearview mirror's post 36 or stem 38 and the front edge of an automobile's ceiling/headliner 48 where it meets the top edge of the windshield 44.

FIG. 11 is a fragmented, cross-sectional view of the front windshield area of an automobile and a specifically configured version of the preferred embodiment of visor gap shade 20 with a single arch 30 at the center of its bottom longitudinal edge and a windshield-mounted rearview mirror 32 taken along line 7-7 of FIG. 5 with a sun visor 40 and a sun visor mount 42 shown.

FIG. 12 is a fragmented, cross-sectional view of the front windshield area of an automobile and a specifically configured version of an alternate embodiment of visor gap shade 20 with dual arches 30 and 31 and a ceiling/headliner-mounted rearview mirror 32 taken along line 7-7 of FIG. 5 without a sun visor 40 or sun visor mount 42 shown.

FIG. 13 is a fragmented perspective view of an automobile's side door and window as seen from the outside with one of the automobile's sun visors 40 in the down or in use position and a specifically configured version of the preferred embodiment of the visor gap shade 20 fully deployed and placed some distance to the side of a conventional sun visor 40 to extend the shaded area provided by the conventional sun visor 40.

### DRAWINGS—REFERENCE NUMERALS

20 visor gap shade

22 sheet

24 pull tag

26 loop

27 support rings

28 clasp

30 bottom edge centered arch

31 top edge centered arch

32 rearview mirror

34 rearview mirror mount

36 rearview mirror post

38 rearview mirror stem(s)

40 sun visors

42 sun visor mount

44 windshield

46 windshield mounting frame

48 ceiling/headliner

50 roof

52 side door

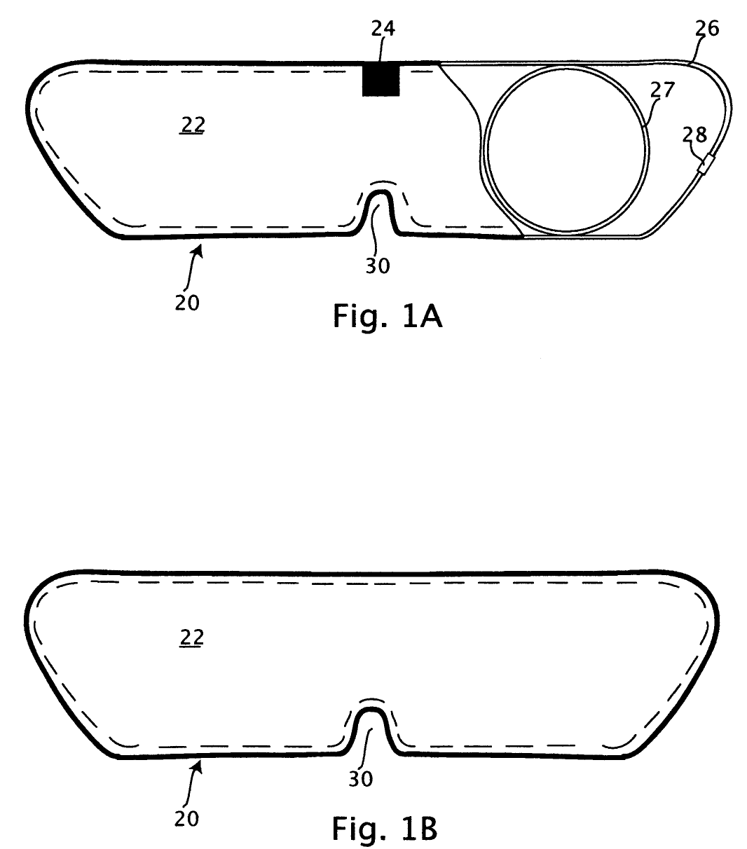

### DETAILED DESCRIPTION—FIGS. 1A AND 1B—PREFERRED EMBODIMENT

Referring to the figures of drawings wherein like reference numerals designate like elements throughout, FIGS. 1A and 1B depict the preferred embodiment of the visor gap shade 20. For ease of illustration and description, the drawings illustrate only the pertinent features of the visor gap shade and do not show the remaining conventional features.

In the preferred embodiment, visor gap shade 20 is in the general shape of a rectangle with its corners slightly rounded, its latitudinal ends at slight angles, its top and bottom longitudinal edges parallel to each other, and its bottom longitudinal edge has an arch 30 at its center. Sheet 22 is in a generally rectangular shape and comprises one or more layers of a flexible material with an elongated, continuous, closed, flexible loop 26 comprised of a thin strip of a spring-like material secured to the perimeter of sheet 22. Sheet 22 can be conveniently made of one or more layers of a densely woven fabric. Alternative materials for sheet 22 include thin plastic, reinforced paper, or plasticized metal foil. Alternative materials for sheet 22 can be tinted, translucent, or opaque. Loop 26 and support ring 27 can be comprised of a thin strip of spring steel, suitable plastic, or some other material having sufficient springiness.

If sheet 22 consists of only one layer of material, support rings 27 can be secured to sheet 22 by sewing them in a hem, and loop 26 can be secured to sheet 22 by sewing it in a hem along the perimeter of sheet 22. If sheet 22 consists of two layers of material, the outer perimeters of both layers can be sewn together with loop 26 and support rings 27 contained between the layers of material. Other ways of securing loop 26 and support rings 27 to sheet 22 will occur to those skilled in the art.

Pull tag 24 is comprised of any material that does not damage sheet 22 nor hinders or prevents visor gap shade 20 from being easily folded into a compact form for storage. Pull tag 24 is of sufficient size and shape to allow a driver to easily grip it between his or her thumb and finger. Pull tag 24 is comprised of a predetermined design that does not interfere with the ease of deployment and efficient, proper, and safe installation of visor gap shade 20. Pull tag 24 is of a predetermined design that does not divert a driver's attention away from the road.

As shown in the cut away portion of FIG. 1A, single loop 26 can be formed by connecting the free ends of an elongated strip of material after it has been bent into the required shape. Support ring 27 can be formed by connecting the free ends of an elongated strip of material after it has been bent into the required shape. Clasp 28 can be comprised of a short piece of metal, the ends of which are crimped or folded over to secure the free ends of loop 26 and support 27. Alternatively, clasp 28 can be comprised of some other material that is capable of maintaining its shape and holding together the free end of loop 26 and support rings 27. Alternatively, a continuous loop 26 and/or support ring can be fabricated by welding the ends together in the case of certain metals, or forming one continuous loop 26 and support rings 27 of material in the case of certain plastics and other materials. Loop 26 and support rings 27, which maintain visor gap shade 20 in an open configuration suitable for use in vehicles with windshield-mounted or ceiling/headliner-mounted rearview mirrors, can have different shapes. In the preferred embodiment, the shape of loop 26 is generally rectangular with slightly rounded corners, its latitudinal ends are at slight angles, its top and bottom longitudinal edges are parallel to each other, and it has a single arch 30 centered at its bottom longitudinal edge.

### OPERATION OF INVENTION—PREFERRED EMBODIMENT

Visor gap shade 20 must be fully deployed, FIG. 1B. Prior to putting a motor vehicle's conventional, pivotal sun visors 40 in the down or in use position, visor gap shade 20 is placed above and behind a motor vehicle's rearview mirror 32, and its bottom centered arch 30 is slipped over the rearview mirror's post 36 or stem 38 connected to the backside of the rearview mirror 32 so that arch 30 frictionally straddles the periphery of the post 36 or stem 38. Pull tag 24 is pulled down, and the top longitudinal edge of visor gap shade 20 is pressed against the motor vehicle's windshield 44. Pull tag 24 is released, and the top longitudinal edge of visor gap shade 20 snaps into place where the motor vehicle's windshield 44 and its ceiling/headliner 48 meet. After visor gap shade 20 has been properly installed as described, the motor vehicle's conventional, pivotable sun visors 40 can be put in the down or in use position. Thus, the visor gap shade 20 rests between the motor vehicle's windshield 44 and its sun visors 40. It may be possible to execute this operation in a manner of seconds with the use of only one hand.

### DESCRIPTION AND OPERATION OF ALTERNATIVE EMBODIMENTS

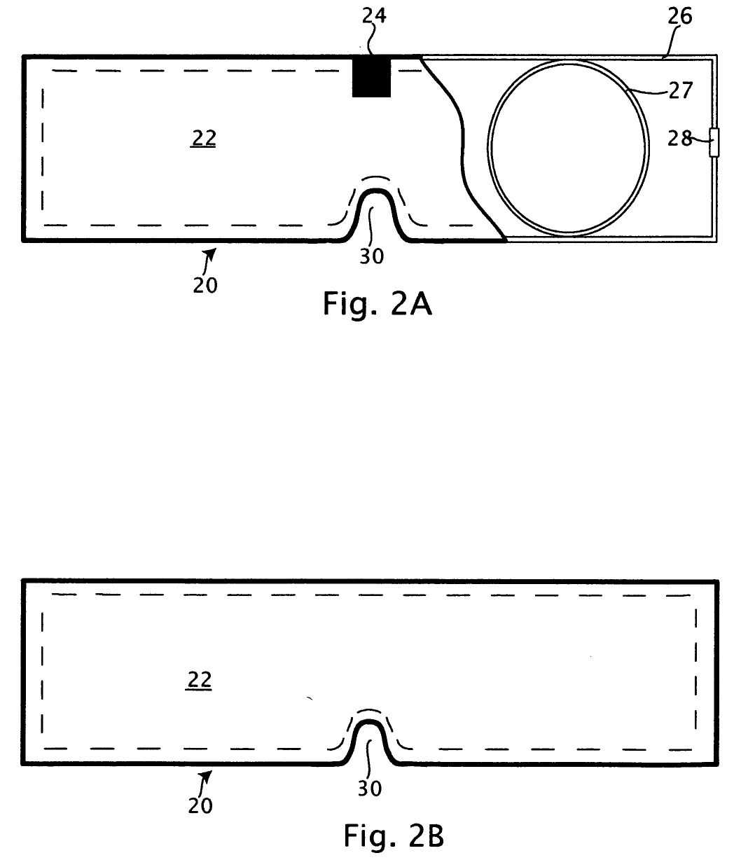

Alternative embodiments of visor gap shade 20 are shown in FIGS. 2A/2B, 3A/3B, 4A/4B, 5A/5B, 6A/6B, 7A/7B, and 8A/8B.

FIGS. 2A and 2B depict the rear and front views, respectively, of an alternative embodiment of the visor gap shade 20 with loop 26 in the shape of a rectangle with square corners, a single arch 30 at the center of its bottom longitudinal edge, and secured to sheet 22. Operation of this embodiment of visor gap shade 20 is identical to the operation of the preferred embodiment of visor gap shade 20 described above for FIGS. 1A and 1B.

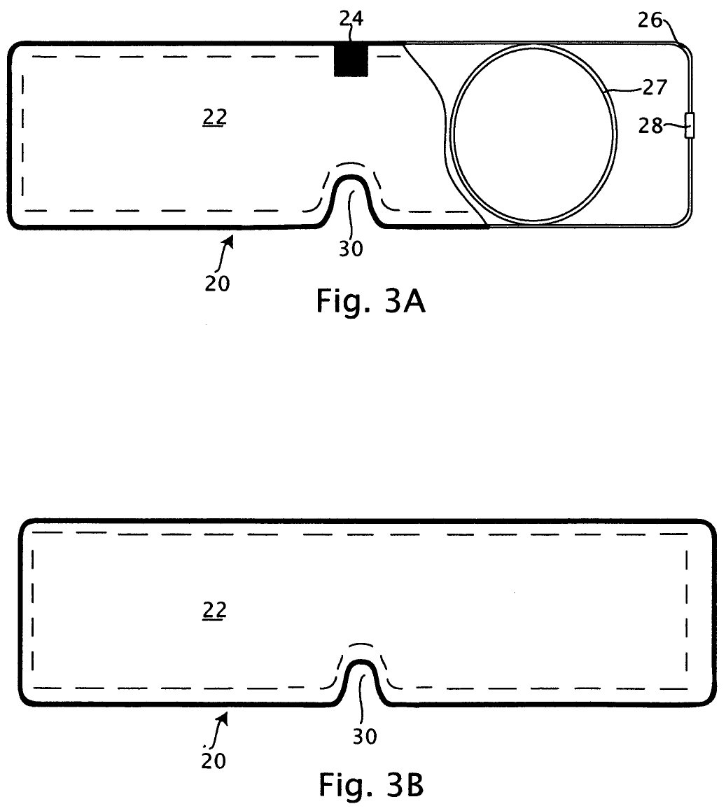

FIGS. 3A and 3B depict the rear and front views, respectively, of an alternative embodiment of the visor gap shade 20 with loop 26 in the shape of a rectangle with slightly rounded corners, a single arch 30 at the center of its bottom longitudinal edge, and secured to sheet 22. Operation of this embodiment of visor gap shade 20 is identical to the operation of the preferred embodiment of visor gap shade 20 described above for FIGS. 1A and 1B.

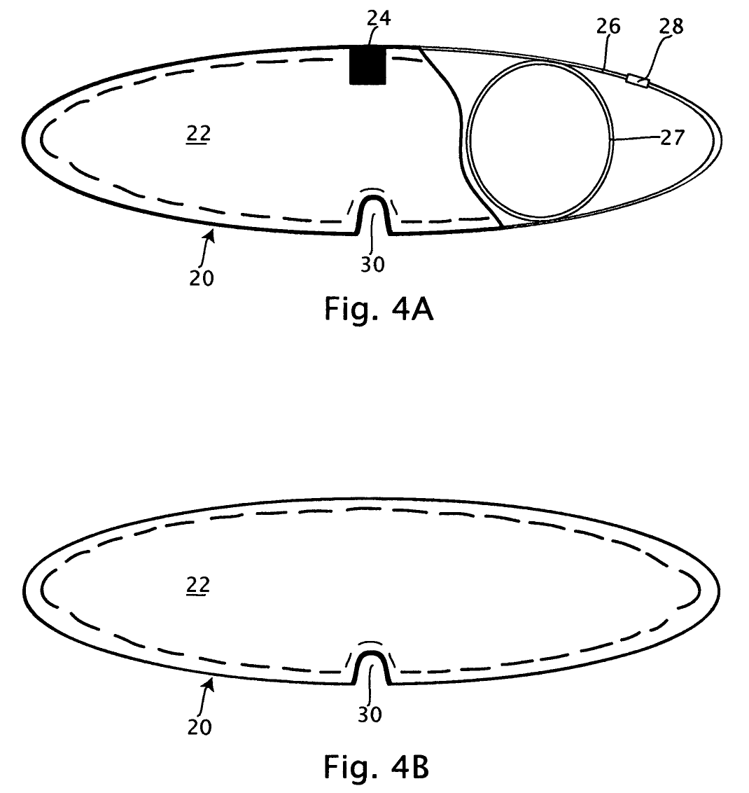

FIGS. 4A and 4B depict rear and front views, respectively, of an alternative embodiment of the visor gap shade 20 with loop 26 in the general shape of an ellipse, a single arch 30 at the center of its bottom longitudinal edge, and secured to sheet 22. Operation of this embodiment of visor gap shade 20 is identical to the operation of the preferred embodiment of visor gap shade 20 described above for FIGS. 1A and 1B.

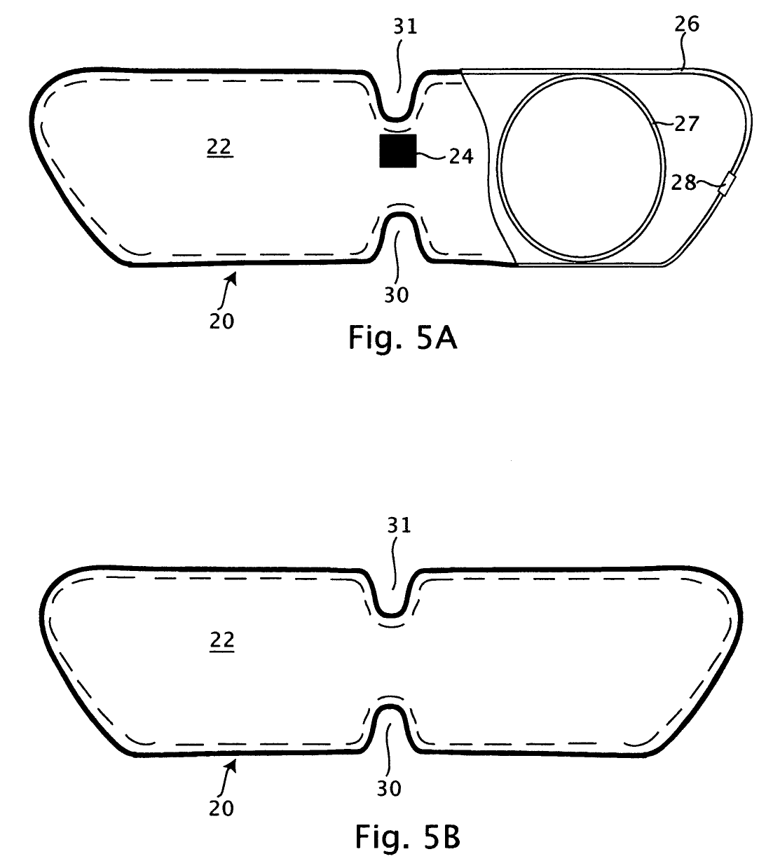

FIGS. 5A and 5B depict the rear and front views, respectively, of an alternative embodiment of visor gap shade 20 with dual arches: one at the center of its top longitudinal edge 31 and the other at the center of its bottom longitudinal edge 30, respectively. Pull tag 24 is placed beneath arch 31 at the center of the top longitudinal edge. Operation of this embodiment of visor gap shade 20 is done prior to putting a motor vehicle's conventional, pivotable sun visors 40 in the down or in use position. Arch 30 at the center of the bottom longitudinal edge is slipped over a rearview mirror's lower stem 38 connected to the rearview mirror's backside and pressed against the rearview mirror post 36. Pull tag 24 is pulled down, and arch 31 at the center of the top longitudinal edge is placed underneath rearview mirror's upper stem 38 which is connected to rearview mirror mount 34. Pull tag 24 is released. After visor gap shade 20 has been properly installed as described, the motor vehicle's sun visors 40 can be put in the down or in use position. Thus, visor gap shade 20 rests between a motor vehicle's front windshield 44 and its sun visors 40. It may be possible to execute this operation in a manner of seconds with the use of only one hand.

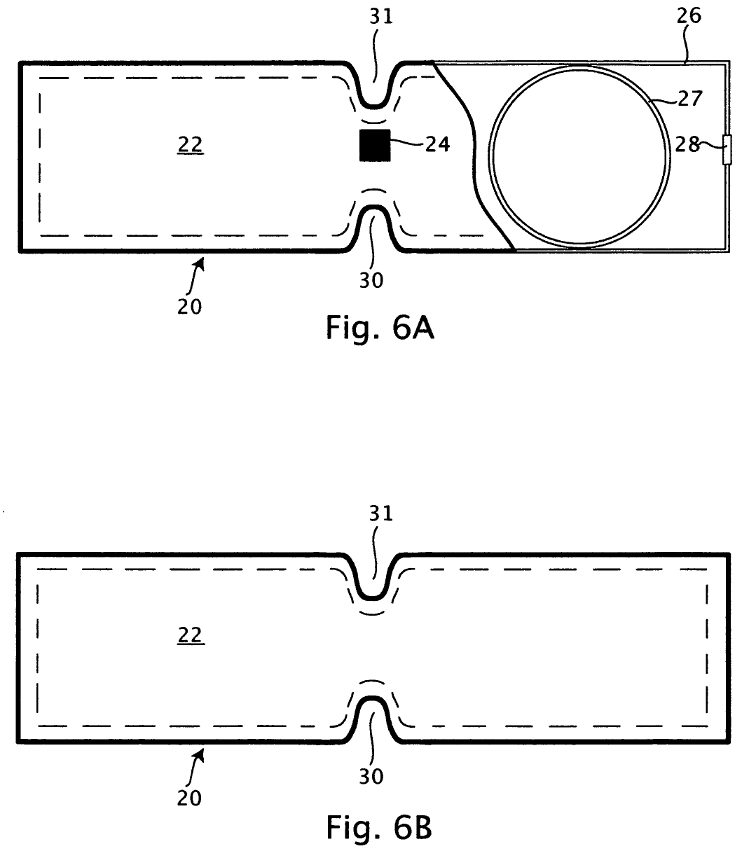

FIGS. 6A and 6B depict the rear and front views, respectively, of yet another alternative embodiment of the visor gap shade 20 shown in FIGS. 2A and 2B: dual arches, one at the center of its top longitudinal edge 31 and the other at the center of its bottom longitudinal edge 30. Operation of this embodiment of visor gap shade 20 is identical to the operation of the alternative embodiment of visor gap shade 20 described above for FIGS. 5A and 5B.

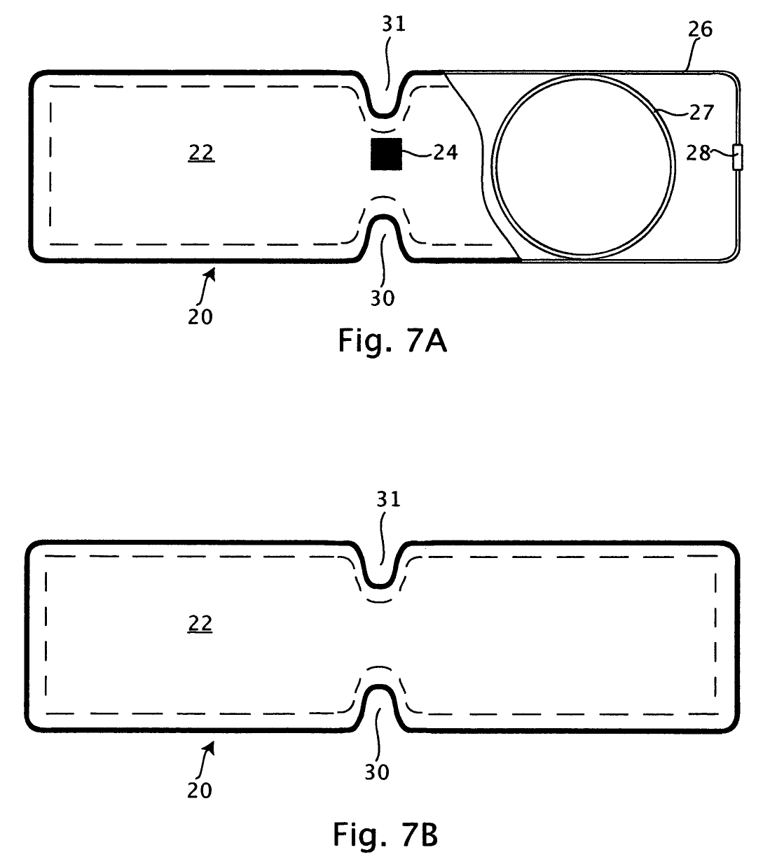

FIGS. 7A and 7B depict the rear and front views, respectively, of still another alternative embodiment of the visor gap shade 20 shown in FIGS. 3A and 3B: dual arches, one at the center of it's top longitudinal edge 31 and the other at the center of its bottom longitudinal edge 30. Operation of this embodiment of visor gap shade 20 is identical to the operation of the alternative embodiment of visor gap shade 20 described above for FIGS. 5A and 5B.

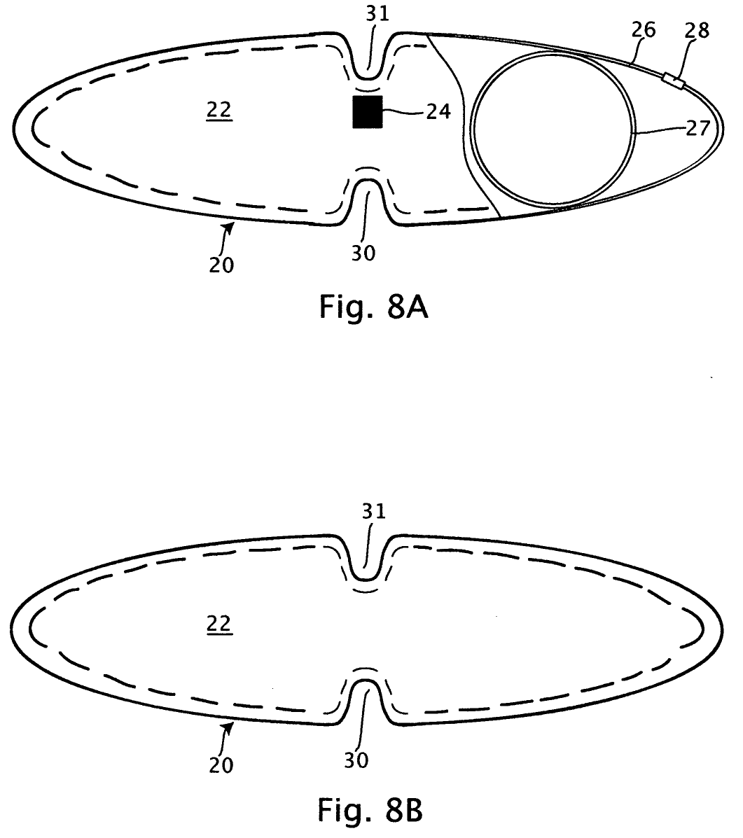

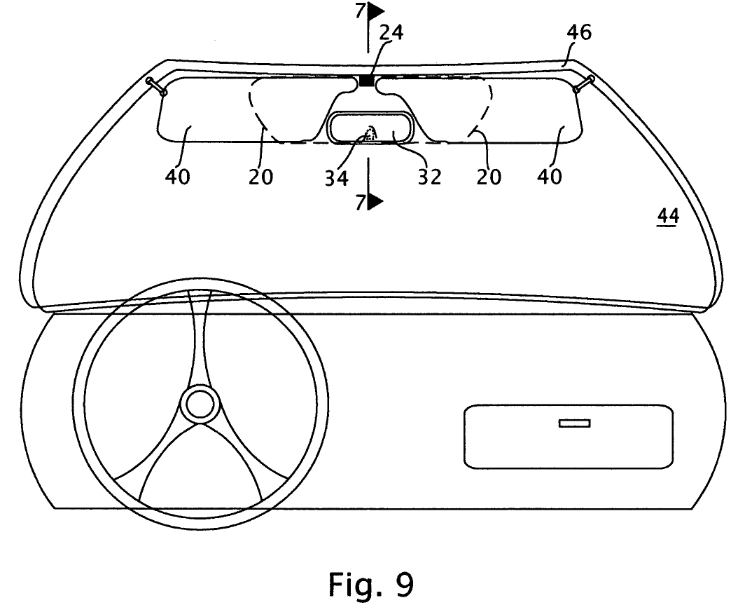

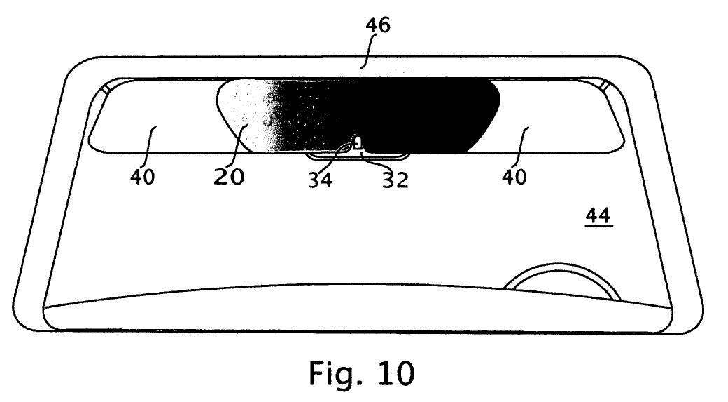

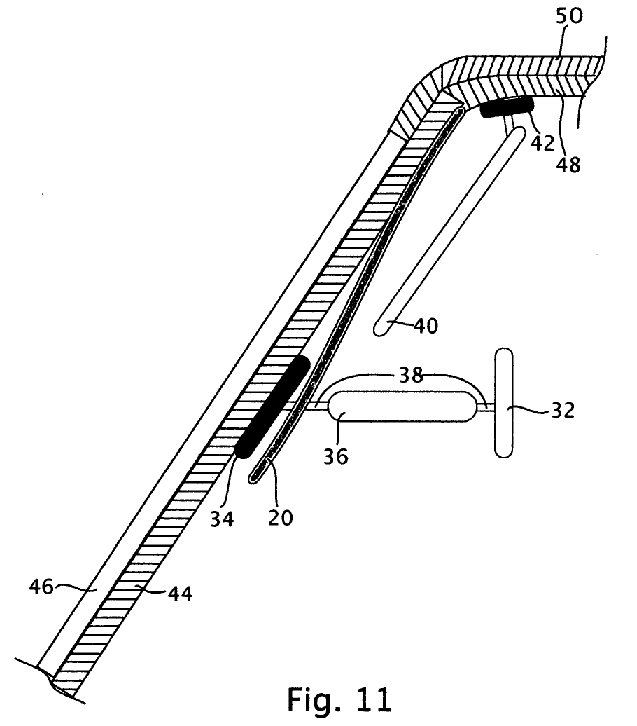

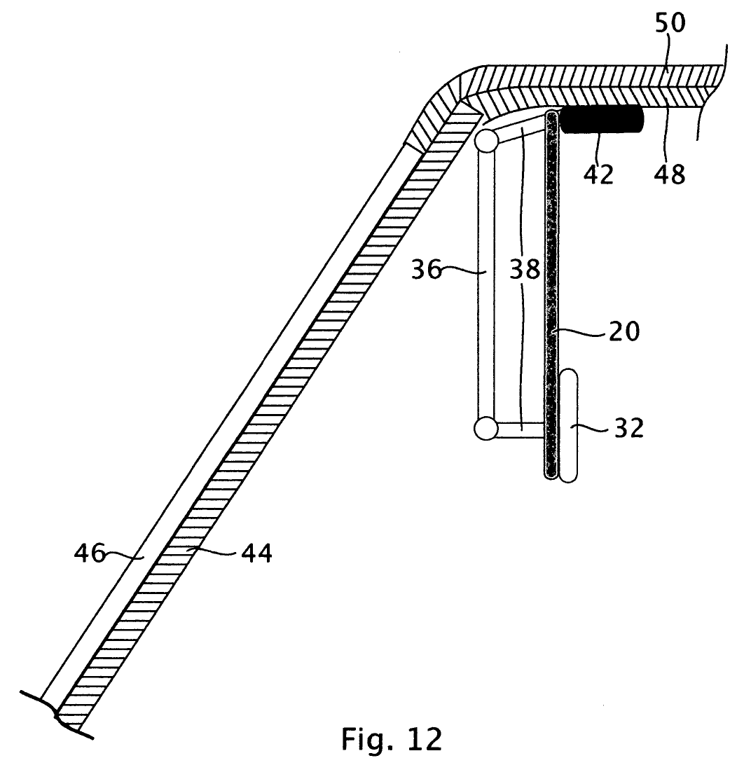

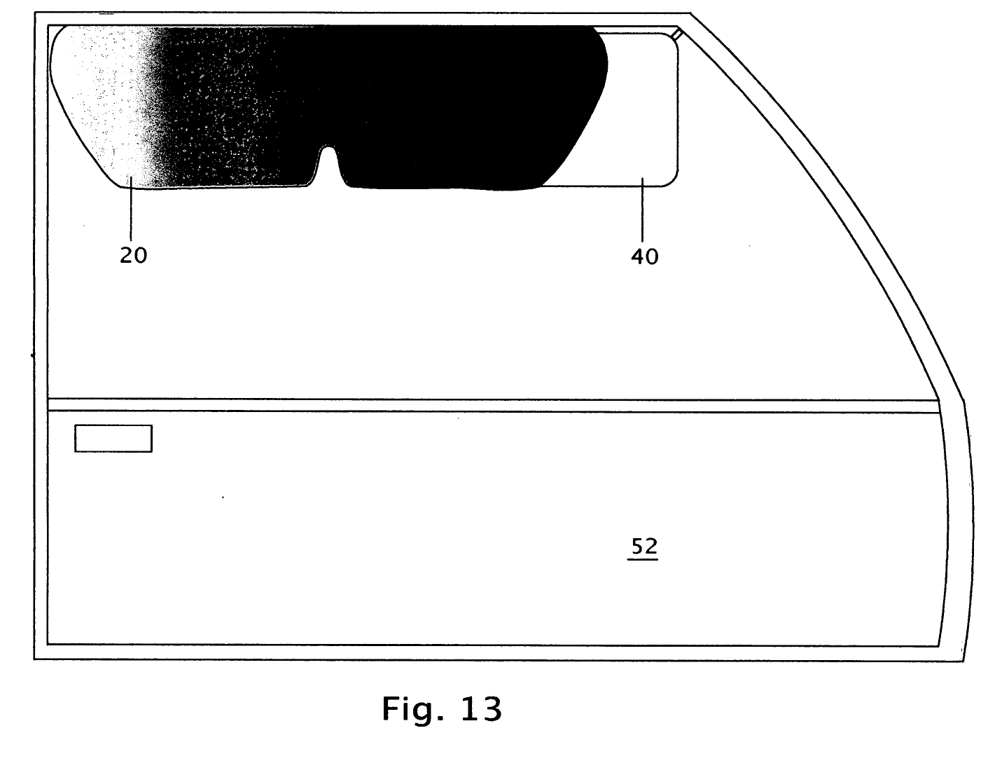

FIGS. 8A and 8B depict the rear and front views, respectively, of yet another alternative embodiment of the visor gap shade 20 shown in FIGS. 4A and 4B: dual arches, one at the center of its top longitudinal edge 31 and the other at the center of its bottom longitudinal edge 30. Operation of this embodiment of visor gap shade 20 is identical to the operation of the alternative embodiment of visor gap shade 20 described above for FIGS. 5A and 5B.

### CONCLUSION, RAMIFICATIONS, AND SCOPE OF INVENTION

Thus, the reader will see that the visor gap shade for motor vehicles equipped with a pair of conventional, pivotable sun visors and a rearview mirror provides a simple, reliable, lightweight, flexible, adjustable, effective, economical, inexpensive, and compactable device that many drivers may deploy and put in place in a few seconds using only one hand.

Furthermore, the visor gap shade has the additional advantage in that
it permits the production of visor gap shades in a variety of textures.
it permits the production of visor gap shades in a variety of colors.
it permits the production of visor gap shades in a variety of shapes.
it permits the production of visor gap shades in a variety of sizes.
it permits the production of visor gap shades in a variety of styles.
it permits the production of visor gap shades in a variety of tints.
it permits the production of visor gap shades in a variety of translucency.
it permits the production of visor gap shades in a variety of opaqueness.
it permits the production of visor gap shades in a variety of materials.
it permits the production of visor gap shades that are collapsible and foldable.
it permits the production of visor gap shades that are not collapsible and foldable.
it permits the production of visor gap shades with pictures, paintings, text, logos, graphics, etc. to be drawn, imprinted, impressed, stamped, written, or otherwise made upon them.

While my description above contains many specificities, they should not be construed as limitations on the scope of the invention but rather as illustrations of the embodiments preferred at present. Many other variations are possible. For example:
it is possible to construct a version of the visor gap shade with a strip of adhesive, Velcro®, or the like, that runs along the length of one or both, front and back, sides near its top and bottom longitudinal edges in order to join it to its counterpart already affixed above a driver's or front seat passenger's side window to provide an extended area of shade in conjunction with a pair of conventional, pivotable sun visors when they are placed and used in the side and down position.
it is possible to construct a version of the visor gap shade with the feature of having one or both, front and back, sides of its pull tag (24) made of a piece of adhesive, Velcro®, or the like of predetermined size in order to join it to its counterpart already affixed above a driver's or front seat passenger's side window to provide an extended area of shade in conjunction with a pair of conventional, pivotable sun visors when they are placed and used in the side and down position.
it is possible to construct a version of the visor gap shade with a reinforced hole of predetermined size centered near its top, bottom, or both longitudinal edge(s) in order to hang it on a hook of predetermined size already affixed above a driver's or front seat passenger's side window to provide an extended area of shade in conjunction with a pair of conventional, pivotable sun visors when they are placed and used in the side and down position.
it is possible to construct a version of the visor gap shade with an arch greater than an established, predetermined height near the center of its top and/or bottom longitudinal edge(s) in order to hang the visor gap shade on a hook of predetermined size already affixed above a driver's or front seat passenger's side window to provide an extended area of shade in conjunction with a pair of conventional, pivotable sun visors when they are placed and used in the side and down position.

Accordingly, the scope of the visor gap shade should be determined not by the embodiment(s) illustrated but by the appended claims and their legal equivalents.

1. The dual purpose visor gap shade, an visor gap shade for bridging the gap between a pair of conventional, pivotable sun visors installed in most motor vehicles at some distance from the ceiling/headliner comprising:
(a) a sheet of one or more layers of flat, tinted, translucent, or opaque, flexible material,
(b) an elongated, continuous, closed loop of spring-like material,
(c) support rings of spring-like material,
(d) said sheet having means for attachment to the perimeter of said loop and support rings,
whereby said visor gap shade prevents sunlight, bright light, and the like from hitting the eyes of a driver and front seat passenger(s).

2. The visor gap shade of claim 1 wherein said loop comprises a generally rectangular, generally elliptical, or generally oval shape.

3. The visor gap shade of claim 2 wherein said shape comprises a sufficient length to span the gap between said pair of sun visors.

4. The visor gap shade of claim 2 wherein said shape comprises a lesser, equal, or greater width of said pair of sun visors.

5. The visor gap shade of claim 1 wherein said loop comprises an arch of sufficient height and width to frictionally straddle the periphery of a mounting post or stem connected to the back of a conventional rearview mirror installed in said vehicle.

6. The visor gap shade of claim 5 wherein said arch is located at the center of either one or both longitudinal edges.

7. The visor gap shade of claim 6 wherein said longitudinal edges are able to conform to the contour of the ceiling/headliner portion of said vehicle at the uppermost end of the windshield.

8. The visor gap shade of claim 1 wherein said sheet comprises means for attachment near one or both longitudinal edges.

9. The visor gap shade of claim 8 wherein said means for attachment comprises either one or both, front and back, sides of said sheet.

10. The visor gap shade of claim 9 wherein said means for attachment comprises a strip of adhesive, Velcro®, or the like running the length of said visor gap shade,
whereby said visor gap shade can be joined to the counterpart of said strip already affixed to the ceiling/headliner above the driver's or front seat passenger's side door and provide an extended area of shade in conjunction with said pair of conventional, pivotable sun visors when they are placed and used in the side and down position.

11. The visor gap shade of claim 8 wherein said means for attachment comprises one or both, front and back, sides of visor gap shade's pull tag.

12. The visor gap shade of claim 11 wherein said pull tag comprises a piece of adhesive, Velcro®, or the like of predetermined size,
whereby said visor gap shade can be joined to the counterpart of said strip already affixed to the ceiling/headliner above a driver's or front seat passenger's side window to provide an extended area of shade in conjunction with said pair of conventional, pivotable sun visors when they are placed and used in the side and down position.

13. The visor gap shade of claim 8 wherein said means for attachment comprises a hole of predetermined size,
whereby said visor gap shade can be hung on a hook of predetermined size already affixed to the ceiling/headliner above the driver's or front seat passenger's side window to provide an extended area of shade in conjunction with said pair of conventional, pivotable sun visors when they are placed and used in the side and down position.

14. The visor gap shade of claim 8 wherein said means for attachment comprises an arch greater than an established, predetermined height,
whereby said visor gap shade can be hung by its arch on a hook of predetermined size already affixed to the ceiling/headliner above the driver's or front seat passenger's side window to provide an extended area of shade in conjunction with said pair of conventional, pivotable sun visors when they are placed and used in the side and down position.

15. The visor gap shade of claim 1 wherein said visor gap shade can be twisted to form a pair of layered sections to form a compact configuration for storage.

16. The visor gap shade of claim 1 wherein the restoring forces of said spring-like material of said loop makes possible the retention of said visor gap shade's shape.

17. The visor gap shade of claim 1 wherein said visor gap shade can not be be collapsible or foldable.
